(19) United States
(12) Patent Application Publication
(10) Pub. No.: US 2005/0120838 A1
(43) Pub. Date: Jun. 9, 2005

(54) Driving tool

(76) Inventors: Steven D. Gottlieb, Warrenton, VA (US); Ernest A. Carroll, Clifton, VA (US)

Correspondence Address: BANNER DEVELOPMENT, INC., 19 CHENANGO STREET, SUITE 904, BINGHAMTON, NY, 13901, US

(21) Appl. No.: 11/034,967

(22) Filed: Jan. 14, 2005

Related U.S. Application Data
(63) Continuation-in-part of application No. 10/244,006, filed on Sep. 16, 2002.

(51) Int. Cl. B25B 23/08

(52) U.S. Cl. 81/452

(57) ABSTRACT

A driving tool which slidingly penetrates and engages a rectangular socket formed in one end of a screw or the like. The screw is preferably a dental implant having a threaded and polygonal female socket. The tool has two opposed jaws dimensioned and configured to be received in close cooperation with the socket. The jaws are spaced apart by a gap and compress slightly as they penetrate the socket. The jaws frictionally and resiliently engage the socket, thus enabling the screw to be grasped, maneuvered, and rotatably threaded into place without requiring threaded engagement of tool and screw. The tool is slidably withdrawn after the screw is tightened.

### REFERENCE TO RELATED APPLICATION

This application is related to Ser. No. 10/244,006, filed Sep. 24, 2002.

### BACKGROUND OF THE INVENTION

1. Field of the Invention

The present invention relates to tools, and more particularly to a tool for grasping and driving a screw type device having a polygonal socket formed at one end for receiving a driving tool.

2. Description of the Prior Art

Fasteners and anchors bearing external screw threads are usually installed by rotatably driving them into engagement with a base or supporting stratum. Such fasteners and anchors, which will be referred to hereinafter collectively as screws regardless of their intended purposes, are usually provided with a head having structure for engaging a driving tool, and an elongated shaft which shaft is typically threaded. The shaft advances into the supporting stratum when it is rotated, and may be withdrawn by reversing the direction of rotation. The structure of the head which engages a driving tool may comprise a polygonal external surface at one end of the shaft, such as a hexagonal head or alternatively, a polygonal socket formed at the same end in the absence or in addition to a polygonal external surface. The present invention is concerned with the latter type, wherein the head has a polygonal recess or socket configured to receive a driving bit or blade of a driving tool.

Driving tools typically have a bit or blade which is inserted into the socket and engages the socket by cooperation therewith, such as by abutment. Interference between the socket and the bit assures that the screw device will be driven when the tool is rotated. The tool of the present invention has not only a bit enabling driving of screw devices, but also grasping of the screw device. This ability is imparted by cooperating jaws or prongs which are initially spaced apart from one another and which compress resiliently as they penetrate and contact the socket of the screw. The jaws engage the walls of the socket by friction, assisted by spring action of resistance to further compression of the jaws.

Being able to grasp the screw by a driving tool is very advantageous in miniaturized applications, such as the field of dental implants, eyeglass screws, and machine tool inserts, among others. In dentistry, implants and their various associated components are so small as to be very difficult to maneuver into place by hand. U.S. Pat. No. 5,105,690, issued to Lazarra et al. on Apr. 21, 1992, illustrates a driver tool intended for small dental implants. Manufacturing the driver tool of Lazarra et al. requires forming the bit in two sections of similar cross section, but different configurations as viewed in side elevation. The smaller section, which is not tapered, is a driving section, while the larger tapered section is that intended to engage the walls of a socket by friction.

### SUMMARY OF THE INVENTION

The present invention provides a screw grasping, maneuvering, and driving tool for screws such as fasteners, anchors, and other devices, which tool engages a polygonal socket formed in the head of the screw. The novel tool has at least two opposed jaws separated by a small gap. The jaws are configured to be received in the socket of the screw, having at least a portion of their external surfaces inclined or tapered to facilitate insertion. Insertion into the socket resiliently urges or compresses the jaws towards one another as progressively wider portions of the jaws enter the socket. The screw is then engaged and held by friction and by spring action of the compressed jaws. The tool may be used to transport the screw to its intended location, and to rotatably drive the screw home. Thus only one tool and uncomplicated manipulation of the tool enable the screw to be transported, set in place, and tightened in place.

The novel arrangement of the jaws improves over the device of Lazarra et al., in that less effort is required to machine or otherwise fabricate the driving tool. Notably, in the present invention, the driving and grasping sections are integral with one another. This characteristic enables only one section to be formed during fabrication rather than two sections of different dimensions, as seen in the tool of Lazarra et al. Also, engagement of the screw socket is accomplished not only be elastic compression of the constituent material of the driving tool, as seen in Lazarra et al., but also by resilient compression or spring action of the jaws, which jaws and resilient compression are absent in Lazarra et al.

Accordingly, it is one object of the invention to provide a screw grasping and driving tool which improves over the prior art.

It is another object of the invention to enhance grasp of a socket by utilizing both elastic compression of the constituent material of the driving tool and also spring action.

An additional object of the invention is to reduce difficulty of fabricating a screw grasping and driving tool.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational view of one embodiment of a driving tool according to the invention.

FIG. 2 is an enlarged perspective detail view of the bottom of FIG. 1.

FIG. 3 is similar to FIG. 2, but shows an alternative configuration of the jaws of the driving bit.

FIG. 4 is an enlarged environmental side elevational view of the embodiment of FIG. 1 engaging a screw for driving the latter.

FIG. 5 is an enlarged perspective detail view of FIG. 4, partially broken away to reveal detail.

FIG. 6 is an enlarged perspective detail view of the bottom left of FIG. 2.

FIG. 7 is an enlarged perspective view of a dental implant which may be grasped and driven by the tool of the present invention.

FIG. 8 is an enlarged perspective view of another embodiment of a dental implant which may be grasped and driven by the tool of the present invention.

### DETAILED DESCRIPTION OF THE PREFERRED EMBODIMENTS

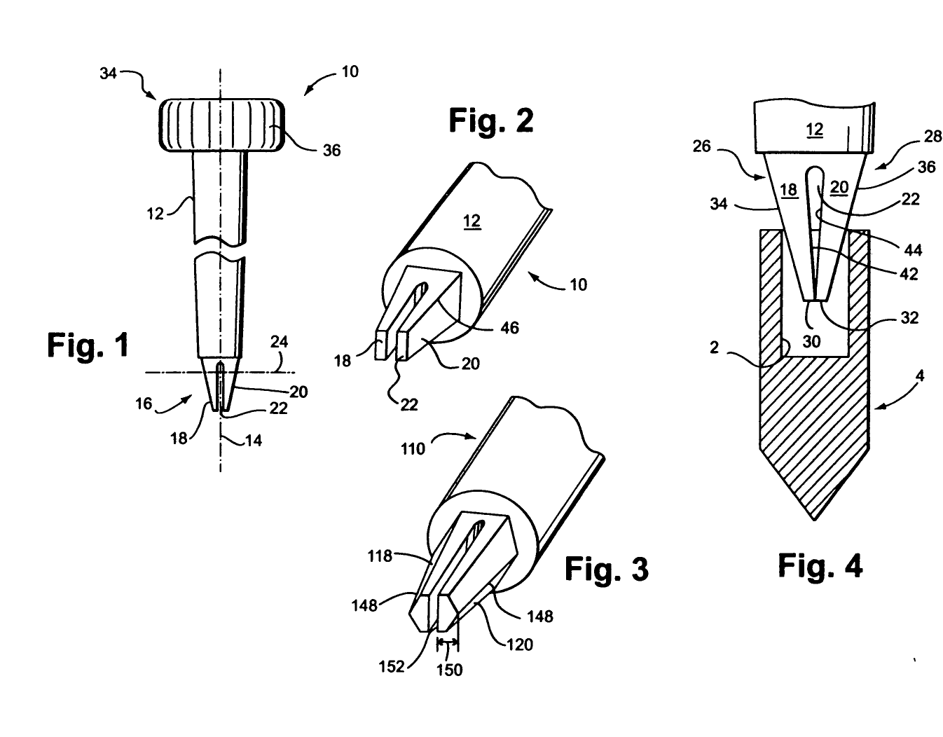

FIG. 1 of the drawings shows a driving tool 10 for grasping and rotatably driving a screw (see FIG. 4) of the type having a polygonal female socket for engaging a driving tool. Driving tool 10 comprises a body 12 having an axis of rotation 14 and a driving bit 16 comprising two and only two opposed jaws 18, 20 fixed to and projecting from body 12. Body 12 preferably takes the form of an elongate shaft wherein the length is coincident with axis of rotation 14, as depicted in FIG. 1, although much shorter embodiments are contemplated. A gap 22 spaces apart or separates jaws 18, 20 from one another in the absence of external forces which would otherwise urge jaws 18, 20 towards each other.

Gap 22 may have several sections rather than having configuration of a single straight line segment. For example, in an alternative embodiment of the invention (not shown) having three jaws, a three section gap would separate each jaw from every other jaw. This latter situation applies in particular to polygonal configurations having an odd number of sides, such as triangles and pentagons. When using a polygonal configuration having an even number of sides, such as square, rectangular, and hexagonal, it is preferred to use a gap having configuration of a straight line segment. However, it would be possible to modify this scheme, for example, to remove constituent material to decrease resistance to compression when the jaws are being inserted into a socket.

The gap may intersect the outer periphery of the jaws at a straight face or facet, as illustrated herein, at an intersection of straight faces or facets (this construction is not shown), or in any combination of these.

As clearly seen in FIG. 2, jaws 18, 20 collectively have a drivingly effective generally rectangular outer cross sectional configuration, where the cross sectional configuration is taken on a plane (such as for example plane 24 shown in FIG. 1) oriented perpendicularly to rotational axis 14. Referring also to FIG. 4, wherein jaws 18, 20 of driving tool 10 have entered and engaged a socket 2 of a screw 4, it will be appreciated that the drivingly effective outer peripheral cross sectional configuration cooperates closely with socket 2, thereby enabling driving screw 4 by rotation. It will be appreciated that the same cross sectional configuration occurs at different points along the length of jaws 18, 20, although to progressively increasing dimensions from the end of jaws 18, 20 to body 12.

Although the present invention may have more than two jaws 18, 20 (or 118 and 120 as seen in FIG. 3), it is possible to increase the number of jaws if desired. As complexity of manufacturing increases especially in miniaturized applications, it is preferred to limit the number of jaws to two. Therefore, explanation of the invention will proceed with reference to two jaws, it being understood that this may be varied.

As previously mentioned, the outer peripheral cross sectional configuration of jaws 18, 20 is that of a rectangle. In the embodiment of FIG. 2, this configuration is rectangular, and more specifically square in this embodiment. In an alternative embodiment shown in

FIG. 3, this configuration is hexagonal. In FIGS. 2 and 3, the respective configurations are shown at the distal or relatively small ends of the respective jaws. The embodiment of FIG. 3 is similar to that of FIG. 2 except for the cross sectional configuration of the driving bit. The hexagonal tool is useful for both six- and twelve-pointed sockets (neither shown). In the field of dentistry, twelve pointed sockets are used to provide finer angular positioning of abutments and other components on an osseointegrated implant (not shown).

Jaws 18, 20 engage the walls of socket 2 by friction. Cooperation with socket 2 and frictional grip of socket 2 are enhanced by resilient spring action of jaws 18, 20. Jaws 18, 20, and preferably all of driving tool 10, are fabricated by a material displaying spring characteristics causing jaws 18, 20 to yieldingly and resiliently resist being urged together. Titanium, stainless steel, other steels, synthetic elastomers, and other materials would be suitable for imparting sufficient spring characteristics.

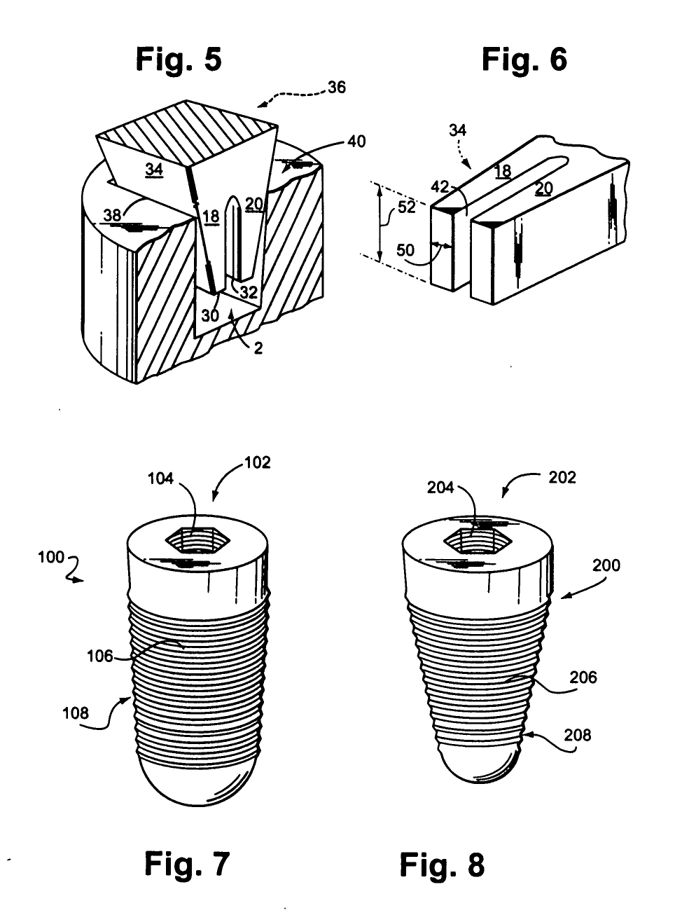

Each jaw 18 or 20 has a respective proximal end 26 or 28 proximate body 12, and a respective distal end 30 or 32 located away from body 12. Each jaw 18 or 20 is tapered such that it is relatively wide at its proximal end 26 or 28, and relatively narrow at its distal end 30 or 32. Taper of jaws 18, 20 is preferably linear and continuous along the entire extent or length of one or preferably both jaws 18, 20. As seen in the enlarged detail of FIG. 5, this taper causes external engagement surfaces 34, 36 of jaws 18, 20 each to establish and maintain a line of contact with an edge of socket 2 when driving tool 10 is inserted into socket 2. External engagement surfaces 34, 36 is that surface of its respective jaw 18 or 20 which faces away from axis of rotation 14. Each jaw 18 or 20 has one and only one external engagement surface 34 or 36. In FIG. 5, edges 38, 40 are coincident with the lines of contact made by jaws 18, 20. Each jaw 18 or 20 of the embodiment of FIG. 2 and each jaw 118 or 120 of tool 110 of FIG. 3 is configured and dimensioned substantially as a mirror image or alternatively stated, similarly to every other jaw (18 or 20, or 118 or 120) of its respective tool 10 or 110.

As best shown in FIG. 4, it will further be seen that each jaw 18 or 20 comprises one and only one single faceted interior surface 42 or 44 facing axis of rotation 14. As used herein, “single faceted” need not imply that the subject surface be purely planar, but rather that it be devoid of sharp edges or creases such as edge 46 (see FIG. 2) or edge 148 (see FIG. 3). Interior surfaces 42, 44 are parallel to one another when in the uncompressed state. Moreover, interior surfaces 42, 44 each face one another. As each jaw 18 or 22 is rectangular in cross section, it follows that for each jaw 18 or 20, its respective external engagement surface 34 or 36 is separated or spaced apart from a corresponding single faceted interior surface by first and second lateral surfaces (not identified by reference numerals).

Of course, the same holds true for the embodiment of FIG. 3. In the embodiment of FIG. 4, as jaws 18, 20 are progressively inserted into socket 2, they are compressed together so that they come to touch one another at their respective distal ends 30, 32. However, it is not necessary to compress jaws 18, 20 to the point that distal ends 30, 32 touch one another for engagement of screw 4 to succeed.

As shown in FIG. 6, jaw 18 has thickness 50 defined between interior surface 44 and external engagement surface 34. Width of jaw 18 is defined along the extent of interior surface 42, and is indicated at 52. It will be seen that width 52 is greater in magnitude than is thickness 50. This same relationship holds true for jaw 20 and also for jaws 118 and 120 in the embodiment of FIG. 3, where thickness is indicated as 150 and width as 152 for jaw 120 (the same applying to jaw 118).

Referring again to FIG. 1, body 12 of driving tool 10 is seen to have a grasping handle 34 of diameter greater than that of body 12. Handle 34 of body 12 bears an outer surface which is textured to improve grip by hand. Texturing may take the form of ridges or reeding 36, by roughening of the surface (not shown), or in any other suitable way. In an alternative embodiment of the invention (not shown), the outer surface being treated to improve grip may be of body 12 rather than being that of enlarged head 34. The same texturing used with handle 34 may be applied to body 12.

In the embodiment of FIG. 1, which is the currently preferred embodiment, body 12 comprises an elongate shaft having length coincident with axis of rotation 14. In the preferred embodiment, jaws 18, 20 project from body 12 parallel to and coaxially with axis of rotation 14. However, this orientation is not absolutely necessary. Rather, some offset is possible, so that in an alternative embodiment (not shown), the jaws may depart from axial alignment with the shaft or body of the tool.

FIG. 7 illustrates a dental implant 100 having an internal connector which takes the form of a polygonal socket 102. Dental implants differ from most screw devices in having internal threads 104 formed in the walls of socket 102 and preferably also external threads 106. FIG. 8 shows a dental implant 200 also having a polygonal socket 202 and threads 204, but having a tapered shaft 208, in contrast to the generally cylindrical shaft 108 of the embodiment of FIG. 7. Dental implants also are devoid of enlarged heads which are typical of tool driven screws used for general purpose fastening, where enlarged heads have greater diameter than shafts 108, 208.

A significant advantage of driving a dental implant with the novel tool is that whereas unthreading a screw which is conventionally used to drive the implant may actually unthread the implant from bone tissue, pulling the novel tool from the implant does not counterrotate the implant, thereby avoiding potential unthreading.

It is to be understood that the present invention is not limited to the embodiments described above, but encompasses any and all embodiments within the scope of the following claims.

1. A driving tool for grasping and rotatably driving a screw having a polygonal female socket for being driven by a polygonal driver,
said driving tool comprising an elongated shaft having an axis of rotation and length coincident with said axis of rotation, and a driving bit including two and only two jaws projecting from said elongated shaft parallel to said axis of rotation, and a gap spacing apart each one of said at least two opposed jaws in the absence of external forces which would urge said at least two opposed jaws towards each other, wherein
each one of said two jaws
has a proximal end proximate said body and a distal end located away from said body, and is tapered along its entire length such that said jaw is relatively wide at said proximal end and continuously becomes relatively narrow at said distal end, and is narrowest at said distal end of said two jaws, such that inserting each one of said jaws into the polygonal socket resiliently urges each one of said two jaws towards one another,
is fabricated integrally with said body from a material displaying spring characteristics causing each one of said two jaws to yield to pressure urging each one of said two jaws yieldingly and resiliently to resist being urged together,
is configured and dimensioned similarly to and substantially as a mirror image of the other one of said two jaws,
has one and only one single faceted interior surface facing said axis of rotation, one and only one external engagement surface facing away from said axis of rotation, a first lateral surface disposed between and spacing apart said single faceted interior surface and said external engagement surface, and a second lateral surface disposed between and spacing apart said single faceted interior surface and said external engagement surface,
has thickness defined between said single faceted interior surface and said external engagement surface, and
width defined along the extent of said interior surface, and said width is greater in magnitude than is said thickness;
wherein said single faceted interior surfaces are parallel to one another; and
said two jaws collectively have a drivingly effective rectangular outer peripheral cross sectional configuration, where said cross sectional configuration is taken on a plane oriented at a perpendicular angle to said axis of rotation, and said cross sectional configuration enables interfering driving engagement of the socket of the screw,
wherein said external engagement surfaces of each one of said two jaws are dimensioned and configured to establish and maintain a line of contact with each one of two opposed edges of the socket when said driving tool is inserted into the socket.

2. The driving tool according to claim 1, wherein said body bears an outer surface which is textured to improve grip by hand.

3. The driving tool according to claim 1, further comprising a grasping handle fixed to said body, wherein the handle has a diameter greater than that of said body.

4. The driving tool according to claim 3, wherein said handle bears an outer surface which is textured to improve grip by hand.

5. A combination including a driving tool and a corresponding screw to be grasped, maneuvered, and driven thereby, wherein
said screw comprises a shaft bearing external threads having a first end and an opposed second end, and a polygonal socket having walls and edges at said first end; and
said driving tool comprises an elongated shaft having an axis of rotation and length coincident with said axis of rotation, and a driving bit including two and only two jaws projecting from said elongated shaft parallel to said axis of rotation, and a gap spacing apart each one of said at least two opposed jaws in the absence of external forces which would urge said at least two opposed jaws towards each other, wherein
each one of said two jaws
has a proximal end proximate said body and a distal end located away from said body, and is tapered along its entire length such that said jaw is relatively wide at said proximal end and continuously becomes relatively narrow at said distal end, and is narrowest at said distal end of said two jaws, such that inserting each one of said jaws into the polygonal socket resiliently urges each one of said two jaws towards one another,
is fabricated integrally with said body from a material displaying spring characteristics causing each one of said two jaws to yield to pressure urging each one of said two jaws yieldingly and resiliently to resist being urged together,
is configured and dimensioned similarly to and substantially as a mirror image of the other one of said two jaws,
has one and only one single faceted interior surface facing said axis of rotation, one and only one external engagement surface facing away from said axis of rotation, a first lateral surface disposed between and spacing apart said single faceted interior surface and said external engagement surface, and a second lateral surface disposed between and spacing apart said single faceted interior surface and said external engagement surface,
has thickness defined between said single faceted interior surface and said external engagement surface, and
width defined along the extent of said interior surface, and said width is greater in magnitude than is said thickness;
wherein said single faceted interior surfaces are parallel to one another; and
said two jaws collectively have a drivingly effective rectangular outer peripheral cross sectional configuration, where said cross sectional configuration is taken on a plane oriented at a perpendicular angle to said axis of rotation, and said cross sectional configuration enables interfering driving engagement of the socket of the screw,
wherein said external engagement surfaces of each one of said two jaws are dimensioned and configured to establish and maintain a line of contact with each one of two opposed edges of the socket when said driving tool is inserted into the socket.

6. The combination of claim 5, wherein said screw is devoid of an enlarged head, and has threads formed in said walls of said socket.

7. The combination of claim 5, wherein said shaft of said screw is tapered.
